(19) United States
(12) Patent Application Publication
(10) Pub. No.: US 2026/0037162 A1
(43) Pub. Date: Feb. 5, 2026

(54) DATA COMPARISON METHOD, MEMORY DEVICE AND MEMORY CONTROLLER

(71) Applicant: MACRONIX INTERNATIONAL CO., LTD., Hsinchu (TW)

(72) Inventors: Ming-Liang WEI, Kaohsiung City (TW); Hsiang-Pang LI, Zhubei City (TW); Ming-Hsiang TSAI, Taichung City (TW); Chia-Lin YANG, Taipei City (TW)

(21) Appl. No.: 19/199,473

(22) Filed: May 6, 2025

Related U.S. Application Data
(60) Provisional application No. 63/678,548, filed on Aug. 2, 2024.

(51) Int. Cl. G06F 3/06

(52) U.S. Cl. CPC G06F 3/0625; G06F 3/0659; G06F 3/0679

(57) ABSTRACT

The application provides a data comparison method, a memory device, and a memory controller. A pre-seeding operation is performed on input data to pre-screen a plurality of candidate matching input data and a plurality of first mismatching input data. A group test is performed on the candidate matching input data to compare the candidate matching input data with a plurality of reference data to generate a matching result, thereby distinguishing a plurality of matching input data and a second mismatching input data from the candidate matching input data, wherein the matching result indicates information about the matching input data which matches the reference data, while the second mismatching input data does not match the reference data.

This application claims the benefit of U.S. provisional application Ser. No. 63/678,548, filed Aug. 2, 2024, the disclosure of which is incorporated by reference herein in its entirety.

### TECHNICAL FIELD

The disclosure relates to a data comparison method, a memory device, and a memory controller.

### BACKGROUND

Genomic sequence analysis decodes and interprets the DNA of an organism, providing critical insights for various biological and medical applications. Next-Generation Sequencing (NGS) enables high-throughput sequencing, but requires significant computational resources to reconstruct fragmented reads into a complete sequence.

FIG. 1 shows a schematic diagram of comparing sample fragments to a reference sequence. As illustrated in FIG. 1, by comparing the sample fragments to the reference sequence, it is possible to determine whether the sample fragments match the reference sequence.

In current genomic sequence analysis, the sample fragments and reference subsequences stored in flash memory are pre-sorted and loaded into dynamic random access memory (DRAM). A controller performs the sequence alignment to verify if the sample fragments are identical to the reference subsequences.

FIG. 2 illustrates a schematic diagram of aligning (comparing) sorted sample fragments to the reference sequence. The sample fragments and the reference sequence can be pre-sorted offline in ascending order. Since the sample fragments and reference sequence are already sorted, this implies: (1) Aᵢ>Aⱼ and Bᵢ>Bⱼ, where i>j (i and j are positive integers), A represents the sample fragment, and B represents the reference sequence. (2) If Aᵢ>Bₖ, and Aⱼ>Aᵢ, then for all s≤k (s and k are positive integers), Aⱼ>Bₛ.

In FIG. 2, at t=0, after alignment, Aᵢ>Bₛ₋₂. At t=1, after alignment, Aᵢ>Bₛ₋₁. At t=2, after alignment, Aᵢ=Bₛ, meaning Aᵢ matches Bₛ. Since Aᵢ has been aligned as a match, the next step is to align Aᵢ₊₁. Given that Aᵢ>Bₛ₋₁ and Bₛ₋₂, it implies Aᵢ₊₁>Bₛ₋₁ and Bₛ₋₂, so at t=3, when aligning Aᵢ₊₁, the alignment between Aᵢ₊₁ and Bₛ can proceed without aligning Aᵢ₊₁ to Bₛ₋₁ or Bₛ₋₂.

However, this conventional alignment method inevitably involves significant data movement between flash memory (where sample fragments and reference sequences are stored) and DRAM, and such large data movement can become a bottleneck in improving performance.

Therefore, how to efficiently enhance the performance of data comparison methods, such as those used in genomic sequence analysis, which require large-scale data comparison, is one of the key areas of focus in the industry.

### SUMMARY

According to one embodiment, a data comparison method applied to a memory system is provided. The data comparison method comprises: performing a pre-seeding operation on a plurality of input data stored in a plurality of storage units to pre-screen a plurality of candidate matching input data and a plurality of first mismatching input data; and performing a group test on the candidate matching input data by a plurality of in-memory search (IMS) units to compare the candidate matching input data with a plurality of reference data stored in the plurality of IMS units to generate a matching result, thereby distinguishing a plurality of matching input data and a second mismatching input data from the candidate matching input data, wherein the matching result indicates information about the matching input data which matches the reference data, while the second mismatching input data does not match the reference data.

According to another embodiment, an In-Memory Search (IMS) device is provided. The In-Memory Search (IMS) device comprises: a plurality of IMS memory blocks for storing multiple reference data; an accumulator coupled to the IMS memory blocks; a selection bit vector generation unit, used to generate a selection bit vector, where the selection bit vector is used to select a plurality of target IMS memory blocks from the IMS memory blocks, and the target IMS memory blocks compare the reference data with a plurality of input data to generate a plurality of IMS comparison results, the accumulator accumulating the IMS comparison results from the target IMS memory blocks; and a checking unit used to compare the selection bit vector with the IMS comparison results to generate a comparison result, the comparison result used to identify a mismatching input data from the input data, wherein the mismatching input data does not match the reference data.

According to an alternative embodiment, a memory controller is provided. The memory controller comprises: a control unit coupled to and controlling a plurality of storage units and a plurality of IMS (in-memory search) units; a pre-seeding filter coupled to the control unit; and a group test decoder coupled to the IMS units for decoding a group test result from the IMS units and sending a group test decoding result to a host. The pre-seeding filter performs a pre-seeding operation on a plurality of input data stored in the storage units to pre-screen a plurality of candidate matching input data and a plurality of first mismatching input data. The IMS units perform a group test on the candidate matching input data to compare the candidate matching input data with a plurality of reference data stored in the plurality of IMS units to generate a matching result, thereby distinguishing a plurality of matching input data and a second mismatching input data from the candidate matching input data, wherein the matching result indicates information about the matching input data which matches the reference data, while the second mismatching input data does not match the reference data. The IMS units send a plurality of group test results to the group test decoder to generate a group test decoding result which is used to distinguish or indicate the second mismatching input data.

### BRIEF DESCRIPTION OF THE DRAWINGS

FIG. 1 shows a schematic diagram of comparing sample fragments to a reference sequence.

FIG. 2 illustrates a schematic diagram of aligning (comparing) sorted sample fragments to the reference sequence.

FIG. 3 illustrates a functional block diagram of a memory system according to an embodiment of the application.

FIG. 4 shows the data comparison method according to an embodiment of the application.

FIG. 5 shows a structure for showing data comparison according to an embodiment of the application.

FIG. 6 shows a pre-seeding operation for converting data into binary vectors according to an embodiment of the application.

FIG. 7 shows a circuit diagram of the IMS unit 330 in an embodiment of the application.

FIG. 8 shows an operational diagram of the IMS units 330 according to an embodiment of the application.

FIG. 9 shows a schematic diagram of IMS operation according to an embodiment of the application.

FIG. 10 shows generation of the test matrix and the selection bit vector according to one embodiment of the application.

FIG. 11 shows a diagram illustrating how to identify the mismatched data from the group test decoding result according to an embodiment of the application.

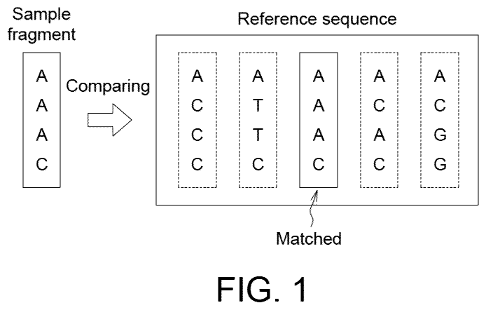

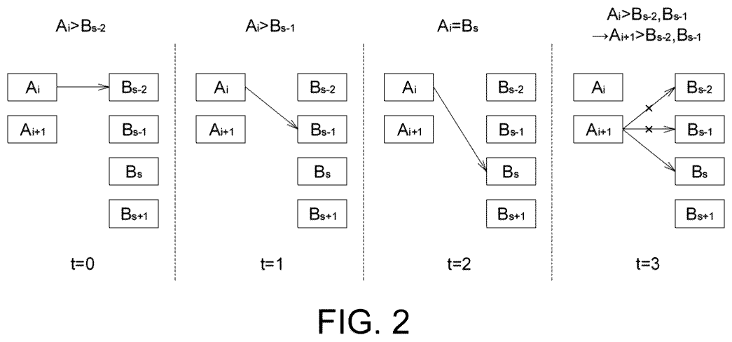

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

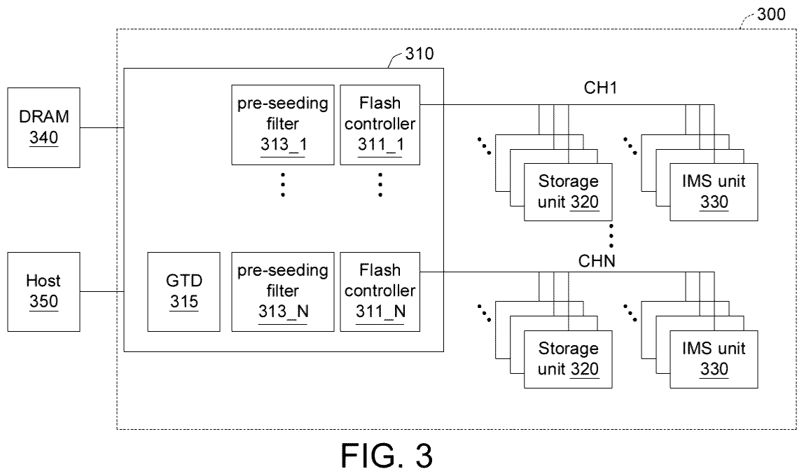

FIG. 3 illustrates a functional block diagram of a memory system according to an embodiment of the application. As shown in FIG. 3, the memory system 300 according to the embodiment is coupled to a DRAM 340 and a host 350. The memory system 300 includes: a memory controller 310, multiple storage units 320, and multiple IMS (in-memory search) units 330. The memory controller 310 is coupled to the storage units 320 and the IMS units 330 via multiple channels CH1-CHN (where N is a positive integer). In a possible embodiment of the application, the storage units 320 and the IMS units 330 may be, but are not limited to, NAND flash memories. The storage units 320 store multiple pieces of input data (for example, but not limited to, sample fragments). The IMS units 330 store multiple pieces of reference data (for example, but not limited to, reference sequences).

The memory controller 310 includes multiple flash controllers (also referred to as control units) 311_1-311_N, multiple pre-seeding filters 313_1-313_N, and a group test decoder (GTD) 315.

The flash controllers 311_1-311_N are coupled to the storage units 320, the IMS units 330, and the pre-seeding filters 313_1-313_N. The flash controllers 311_1-311_N control the storage units 320 and the IMS units 330.

The pre-seeding filters 313_1-313_N perform pre-seeding on the input data, stored in the storage units 320, to preliminarily identify which input data matches the reference data.

The group test decoder 315 is coupled to the IMS units 330 through the flash controllers 311_1-311_N and is used to decode the group test results from the IMS units 330 and send the decoded results to the host 350. In another possible embodiment of the application, the group test decoder 315 may be located within the NAND flash memory (e.g., storage units 320), which is also within the scope of the application.

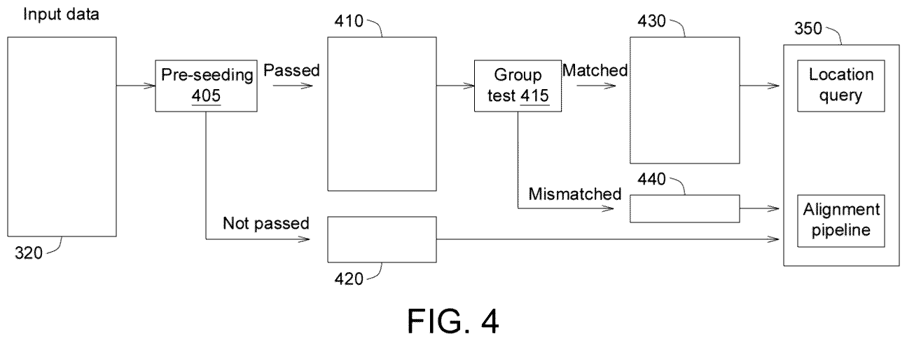

FIG. 4 shows the data comparison method according to an embodiment of the application, which can be applied to the memory system 300 in FIG. 3.

As shown in FIG. 4, the pre-seeding filters 313_1-313_N perform a pre-seeding operation 405 on the input data stored in the storage units 320, to preliminarily identify the input data that is highly likely to match the reference data by performing a matching test on the input data. After pre-seeding, the input data that passes the matching test is therefore highly likely to match the reference data and is referred to as the candidate matching input data 410, while the input data that does not pass the matching test is referred to as the first non-matching input data 420. The reference data stored in the IMS units 330 is unique and not duplicated. That is, after pre-seeding, the input data is classified into the candidate matching input data 410 and the first non-matching input data 420, wherein the candidate matching input data 410 passes the matching test and the first non-matching input data 420 does not passes the matching test.

The first non-matching input data 420 is sent to the host 350 for alignment processing. For example, but not limited to, during genomic sequence analysis, through the alignment processing, sample fragments that do not match the reference sequence (such as the first non-matching input data 420) can be added to the reference sequence.

The candidate matching input data 410 is further processed by the IMS units 330 for group testing 415, to compare the candidate matching input data 410 with the reference data. After group testing, the candidate matching input data 410 that matches the reference data is referred to as the matching input data 430, while the candidate matching input data 410 that does not match the reference data is referred to as the second non-matching input data 440. That is, after group testing, the candidate matching input data 410 is classified into the matching input data 430 and the second non-matching input data 440, wherein the matching input data 430 matches the reference data, and the second non-matching input data 440 does not match the reference data.

The matching result is sent to the host 350 for location query processing, wherein the matching result includes information indicating which input data matches the reference data. In one possible embodiment of the application, the information includes for example but not limited by, which bit lines of the memory block are matched with the reference data.

Similarly, the second non-matching input data 440 is sent to the host 350 for alignment processing, allowing the sample fragments that do not match the reference sequence (such as the second non-matching input data 440) to be added or aligned to the reference sequence.

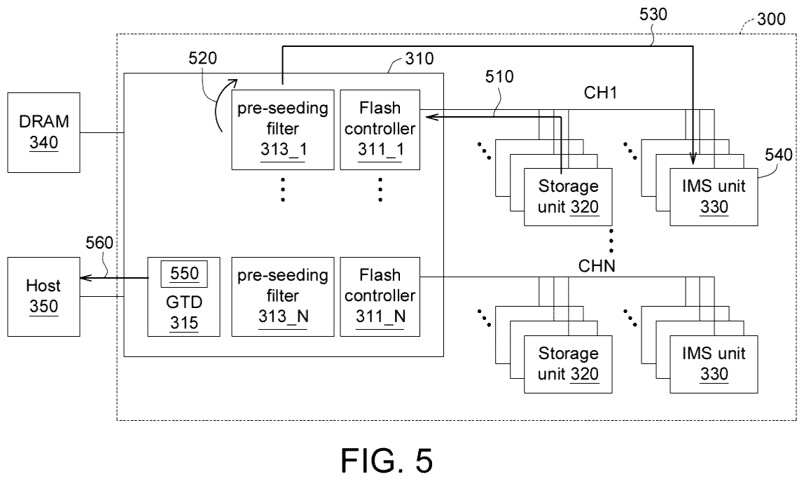

FIG. 5 shows a structure for showing data comparison according to an embodiment of the application, which can be applied to the memory system 300 in FIG. 3. Please refer to both FIG. 4 and FIG. 5.

In step 510, the flash controllers 311_1-311_N read metadata and input data from the storage units 320. The metadata may include, but is not limited to, a reference placement scheme and a pre-seeding filter mask. The terms “reference placement scheme” and “pre-seeding filter mask” are technical terminologies specifically defined by the inventor in the application. The term “reference placement scheme” refers to a table that records the positions of exactly matched comparison results. The term “pre-seeding filter mask” refers to the parameters required for pre-seeding by the pre-seeding filter (such as a Bloom filter) shown in FIG. 3 or FIG. 5. For example, these parameters corresponding to the “pre-seeding filter mask” can serve as filter vectors during the pre-seeding filter mask, working as Bloom filter to filter out most non-matching reads.

In step 520, the pre-seeding filters 313_1-313_N perform a pre-seeding operation 405 on the input data stored in the storage units 320, to preliminarily identify the input data that is highly likely to match the reference data by performing a matching test on the input data. After pre-seeding, the input data that passes the matching test is referred to as the candidate matching input data 410, while the input data that does not pass the matching test is referred to as the first non-matching input data 420.

In step 530, the flash controllers 311_1-311_N send the candidate matching input data 410 to the IMS units 330 for group testing and send the first non-matching input data 420 to the host 350 for alignment processing.

In step 540, the IMS units 330 perform group testing on the candidate matching input data 410, to compare the candidate matching input data 410 with the reference data. After group testing, the candidate matching input data 410 that matches the reference data is referred to as the matching input data 430, while the candidate matching input data 410 that does not match the reference data is referred to as the second non-matching input data 440.

In step 550, the IMS units 330 send the checking of any mismatch during the group tests, referred as group test results, to the group test decoder 315 via the flash controller to decode the group test results transmitted by the IMS units 330, and the group test decoder 315 generates group test decoding results used to identify or indicate the second non-matching input data 440.

In step 560, the group test decoder 315 returns the group test decoding results to the flash controllers 311_1-311_N, allowing the flash controllers 311_1-311_N to send a matching result and the second non-matching input data 440 to the host 350, wherein the matching result includes information indicating which input data matches the reference data.

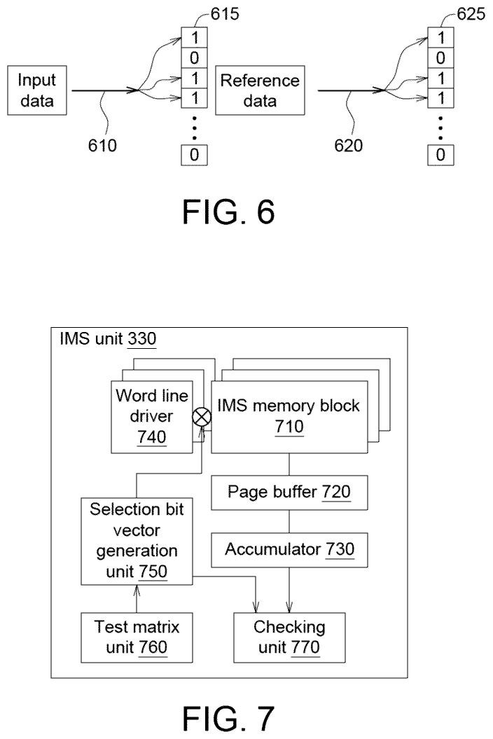

FIG. 6 shows a pre-seeding operation for converting data into binary vectors according to an embodiment of the application. As shown in FIG. 6, the first computation 610 is performed on the input data to obtain a binary vector 615. Similarly, the second computation 620 is performed on the reference data to obtain a binary vector 625. The first computation 610 on the input data and the second computation 620 on the reference data can be performed offline. The first computation 610 and the second computation 620 may include, but are not limited to, a hash function and a mod function.

In one embodiment of the application, the pre-seeding operation is used to preliminarily identify the input data that passes matching test. Generally, when a binary vector 615 of the input data is equal to a binary vector 625 of the reference data, it is determined that the input data passes the matching test, which indicates that there is a high probability that the input data matches the reference data, wherein as described above, the input data that passes the matching test is referred to as the candidate matching input data (410). On the contrary, when the binary vector 615 of the input data is not equal to the binary vector 625 of the reference data, it is determined that the input data fails to pass the matching test, wherein the input data that does not pass the matching test is referred to as the first non-matching input data (420). However, there is still a low probability that the candidate matching input data does not match the reference data. That is, such a determination may still include a small number of false positive input data, meaning that even though the binary vector 615 equals the binary vector 625, the input data does not actually match the reference data. Such data is referred to as false positive input data.

The following will describe the architecture of the IMS units 330 and the details of the group testing in the application.

FIG. 7 shows a circuit diagram of the IMS unit 330 in an embodiment of the application. In a possible embodiment, the IMS unit 330 may have a 3D architecture, for example but not limited to, 3D NAND flash memory architecture or 3D NOR flash memory architecture. As shown in FIG. 7, the IMS unit 330 in this embodiment includes multiple IMS memory blocks 710, a page buffer 720, an accumulator 730, a word line driver 740, a selection bit vector generation unit 750, a test matrix unit 760, and a checking unit 770.

The IMS memory blocks 710 are used to store the reference data. Each IMS memory block 710 stores the same reference data.

The page buffer 720 is coupled to the IMS memory blocks 710 to sense the IMS comparison results.

The accumulator 730 is coupled to the IMS memory blocks 710 to accumulate the IMS comparison results.

The word line driver 740 is coupled to the IMS memory blocks 710 to input the candidate matching input data 410 into the IMS memory blocks 710. In other possible embodiments of the application, other search architectures that can simultaneously access multiple input data may also be used, and the application is not limited to this setup.

The selection bit vector generation unit 750 is used to generate a selection bit vector based on the test matrix to control whether the IMS memory blocks 710 are selected (activated) during the group test process. In other words, the selection bit vector is used to select the IMS memory blocks 710 as target IMS memory blocks 710, which are used to compare the reference data with the input data to generate multiple IMS comparison results. The IMS memory blocks that are not selected do not perform the comparison between the reference data and the input data.

The test matrix unit 760 is used to set the test matrix. In one embodiment of the application, the generation of the test matrix can be performed using a lookup table method or ASIC (Application-Specific Integrated Circuit).

The checking unit 770 is coupled to the accumulator 730 and is used to compare the IMS comparison results with the selection bit vector. For example but not limited by, the checking unit 770 compares a checksum of the IMS comparison results with a checksum of the selection bit vector.

Through this, it is possible to determine whether the candidate matching input data 410 matches the reference data.

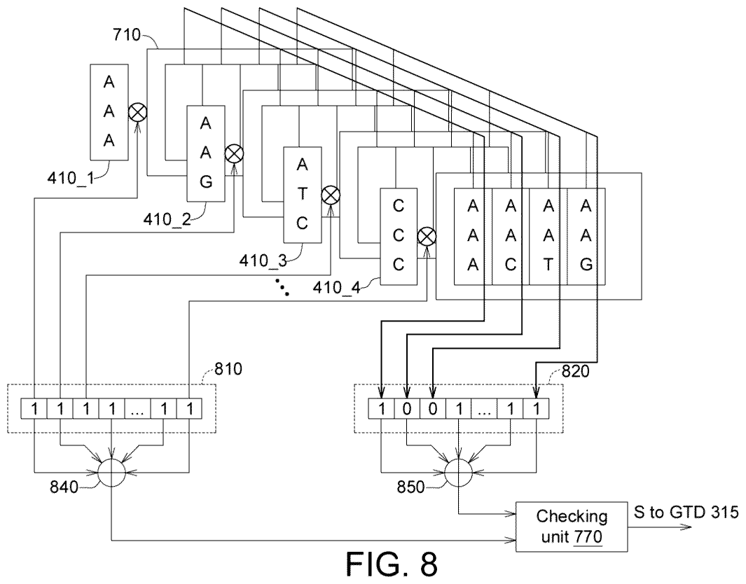

FIG. 8 shows an operational diagram of the IMS units 330 according to an embodiment of the application. As shown in FIG. 8, the selection bit vector 810 controls whether the IMS memory blocks 710 are selected (activated) during the group test process. The IMS memory blocks 710 respectively receive the candidate matching input data 410_1 to 410_4.

After IMS, the IMS memory blocks 710 output IMS results 820 (i.e. the matching results) for the candidate matching input data 410_1 to 410_4. That is, for selected (activated) IMS memory blocks 710, if any of the received candidate matching input data 410_1 to 410_4 matches the reference data of the IMS memory blocks 710, the IMS memory blocks 710 output the first IMS result (e.g, but not limited to, logic 1); and if all of the received candidate matching input data 410_1 to 410_4 does not match the reference data of the IMS memory blocks 710, the IMS memory blocks 710 output the second IMS result (e.g, but not limited to, logic 0).

The selection bit vector 810 and IMS results 820 are processed through arithmetic units 840 and 850, respectively to generate the checksums of the selection bit vector 810 and IMS results 820. The checking unit 770 compares whether the checksum of the IMS results 820 matches the checksums of the selection bit vector 810. If the checksum of the IMS results 820 matches the checksum of the selection bit vector 810, the checking unit 770 outputs a first group test result S (e.g., but not limited to, logic 1); and if the checksum of the IMS results 820 do not match the checksum of the selection bit vector 810, the checking unit 770 outputs a second group test result S (e.g., but not limited to, logic 0). The group test result S is sent from the checking unit 770 to the GTD 315.

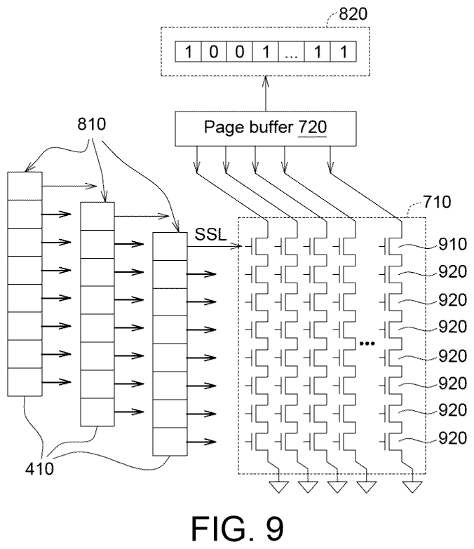

FIG. 9 shows a schematic diagram of IMS operation according to an embodiment of the application. As shown in FIG. 9, the individual bits of the selection bit vector 810 are used as string select line (SSL) input signals to control whether the IMS memory blocks 710 are selected (activated) during the group test process. That is, a first selection bit of the selection bit vectors 810 is input into the SSL switch 910 of a first IMS memory block among the IMS memory blocks 710 to control whether the first IMS memory block 710 is selected (activated) during the group test process. For example, when the first selection bit is logic 1, the SSL switch 910 of the first IMS memory block is turned on, so the first IMS memory block 710 is selected (activated) during the group test process; and when the first selection bit is logic 0, the SSL switch 910 of the first IMS memory block 710 is turned off, so the first IMS memory block 710 is not selected (not activated) during the group test process.

When the first IMS memory block 710 is selected, the multiple IMS cells 920 of the first IMS memory block 710 output sensing currents to the page buffer 720. The page buffer 720 generates the IMS result 820 based on the sensing currents.

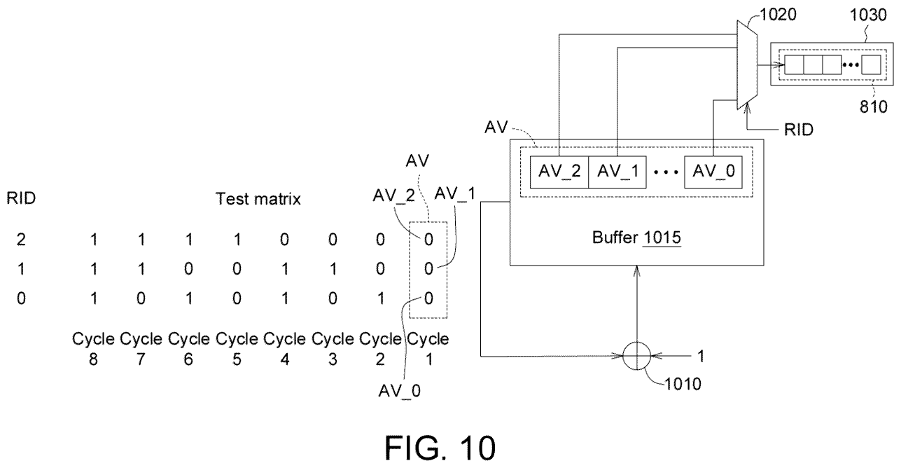

FIG. 10 shows generation of the test matrix and the selection bit vector according to one embodiment of the application. The components in FIG. 10 are located within the IMS unit 330. FIG. 10 shows a possible example of the test matrix, but it should be noted that the application is not limited to this example. Initially, the accumulated value (AV) temporarily stored in the buffer 1015 is, for example but not limited to, 000. After each cycle, the adder 1010 adds an accumulated reference value (e.g., but not limited to, 1) to the accumulated value AV for producing an updated accumulated value AV. The buffer 1015 is coupled to the adder 1010.

The accumulated value AV in the buffer 1015 is output to the multiplexer 1020. The multiplexer 1020 is coupled to the buffer 1015. The multiplexer 1020 selects one of the bits from the accumulated value AV based on the row ID (RID) to output to the first-in-first-out (FIFO) buffer 1030. For example, when the row ID is RID=2, the multiplexer 1020 selects bit AV_2 of the accumulated value AV to output to the FIFO buffer 1030; when the row ID is RID=1, the multiplexer 1020 selects bit AV_1 from the accumulated value AV to output to the FIFO buffer 1030; and when the row ID is RID=0, the multiplexer 1020 selects bit AV_0 from the accumulated value AV to output to the FIFO buffer 1030.

The FIFO buffer 1030 is coupled to the multiplexer 1020. The FIFO buffer 1030 temporarily stores the selection bit output by the multiplexer 1020 and serves as the selection bit vector 810.

The details of generating the selection bit vector 810 will now be explained. In the application, assume the row ID is RID=2, but it should be noted that the application is not limited to this assumption.

In the first cycle, the accumulated value AV is 000, and the multiplexer 1020 selects bit AV_2 (=0) from the multiple bits of the accumulated value AV to output to the FIFO buffer 1030, so the first bit of the selection bit vector 810 is 0.

In the second cycle, the accumulated value AV is 001, and the multiplexer 1020 selects bit AV_2 (=0) from the multiple bits of the accumulated value AV to output to the FIFO buffer 1030, so the second bit of the selection bit vector 810 is 0.

In the third cycle, the accumulated value AV is 010, and the multiplexer 1020 selects bit AV_2 (=0) from the multiple bits of the accumulated value AV to output to the FIFO buffer 1030, so the third bit of the selection bit vector 810 is 0.

In the fourth cycle, the accumulated value AV is 011, and the multiplexer 1020 selects bit AV_2 (=0) from the multiple bits of the accumulated value AV to output to the FIFO buffer 1030, so the fourth bit of the selection bit vector 810 is 0.

In the fifth cycle, the accumulated value AV is 100, and the multiplexer 1020 selects bit AV_2 (=1) from the multiple bits of the accumulated value AV to output to the FIFO buffer 1030, so the fifth bit of the selection bit vector 810 is 1.

In the sixth cycle, the accumulated value AV is 101, and the multiplexer 1020 selects bit AV_2 (=1) from the multiple bits of the accumulated value AV to output to the FIFO buffer 1030, so the sixth bit of the selection bit vector 810 is 1.

In the seventh cycle, the accumulated value AV is 110, and the multiplexer 1020 selects bit AV_2 (=1) from the multiple bits of the accumulated value AV to output to the FIFO buffer 1030, so the seventh bit of the selection bit vector 810 is 1.

In the eighth cycle, the accumulated value AV is 111, and the multiplexer 1020 selects bit AV_2 (=1) from the accumulated value AV to output to the FIFO buffer 1030, making the eighth bit of the selection bit vector 810 equal to 1.

Therefore, the resulting selection bit vector 810 is 00001111.

After each comparison round (i.e., after each group test), the checking unit 770 generates a 1-bit comparison result S, which is sent to GTD 315. The number of comparison rounds needed to identify mismatched data depends on the number of data items to be compared. For example, if the number of data items is N (N is the sample size), at least log (N) comparison rounds are needed to identify the mismatched data.

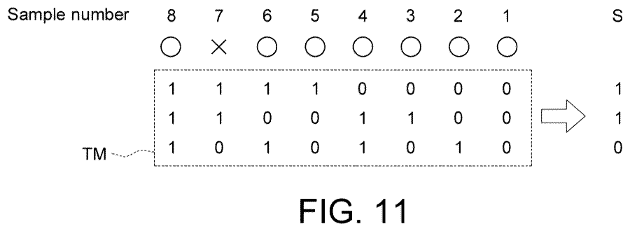

FIG. 11 shows a diagram illustrating how to identify the mismatched data from the group test decoding result according to an embodiment of the application. As shown in FIG. 11, assuming the sample size is 8, after conducting three group tests, three group test results S are obtained. Assuming these three group test results S are 110, then based on the test matrix TM, GTD 315 can decode that the seventh data item (i.e., the seventh sample) does not match the reference data. GTD 315 can then send the group test decoding result (indicating that the seventh data item, i.e., the seventh sample, does not match the reference data) to the host 350. The host 350 can then adjust the alignment processing, and the seventh data item (i.e., the seventh sample), which did not match the reference data, can be added to the reference data (reference sequence).

From the above, it can be seen that in an embodiment of the application, performing matching detection within the memory eliminates the need to externally load the reference sequences, thus reducing the performance bottleneck caused by large data transfers. Moreover, in this embodiment, the use of group testing technology significantly reduces data movement and improves energy efficiency.

In this embodiment, group testing is applied to accelerate the precise matching filtering process, thereby speeding up genomic sequence analysis.

The data comparison method of this embodiment can be applied in various fields, such as, but not limited to, keyword matching for spam detection, genetic disease detection, genome alignment, and more.

By utilizing the data comparison method in this embodiment, the number of samples for group testing can be reduced, further improving data comparison efficiency.

The foregoing primarily describes the solution provided by this application from the perspective of the memory controller. It is understood that to achieve the aforementioned functions, the memory controller may include corresponding hardware structures and/or software modules that perform the functions. Those skilled in the art will easily recognize that the units and algorithm steps described in the embodiments of this specification can be implemented in hardware or firmware form. Whether the function is implemented in hardware or firmware depends on the specific application and design constraints of the technical solution. Those skilled in the art may use different methods to implement the functions described in each specific application, but such implementations should not be considered beyond the scope of this application.

In one embodiment of this application, the memory controller may also be divided into functional modules based on the aforementioned methods. For example, each functional module can be obtained based on each corresponding function, or two or more functions can be integrated into one processing module. It should be noted that in this embodiment of the application, the division into modules is only an example and represents a logical functional division. In actual implementation, other division methods can be used. The application is not limited to this.

Although the application may describe many specific details, these should not be construed as limiting the scope of the claimed invention but rather as a description of the characteristics of certain embodiments. Some features described in the context of a single embodiment can also be implemented in combination in a single embodiment. Conversely, various features described in the context of a single embodiment may be implemented separately or in any suitable subcombination across multiple embodiments. Furthermore, although features may initially be described as functioning in certain combinations, and even though such combinations may initially be claimed, one or more features from the combination may in some cases be removed, and the claimed combination may relate to a subcombination or variation of a subcombination. Likewise, although operations are illustrated as being performed in a specific order in the diagrams, this should not be understood as requiring that such operations must be performed in the specific order shown or in any particular order, nor that all depicted operations are necessary to achieve the desired results.

Although the above embodiment of the application discloses some examples and implementations, based on the disclosed content, changes, modifications, and enhancements can be made to the described examples and implementations, as well as to other implementations.

In summary, although the present invention has been disclosed with the above embodiments, they are not intended to limit the present invention. Those skilled in the relevant technical field may make various changes and modifications without departing from the spirit and scope of the present invention. Therefore, the protection scope of the present invention shall be determined based on the appended claims.

What is claimed is:

1. A data comparison method applied to a memory system, the data comparison method comprising:
performing a pre-seeding operation on a plurality of input data stored in a plurality of storage units to pre-screen a plurality of candidate matching input data and a plurality of first mismatching input data; and
performing a group test on the candidate matching input data by a plurality of in-memory search (IMS) units to compare the candidate matching input data with a plurality of reference data stored in the plurality of IMS units to generate a matching result, thereby distinguishing a plurality of matching input data and a second mismatching input data from the candidate matching input data, wherein the matching result indicates information about the matching input data which matches the reference data, while the second mismatching input data does not match the reference data.

2. The data comparison method according to claim 1, wherein
the candidate matching input data matches the plurality of reference data, and the first mismatching input data does not match the reference data;
the first mismatching input data is sent to the host for alignment processing;
the matching result is sent to the host for location query; and
the second mismatching input data is sent to the host for alignment processing.

3. The data comparison method as described in claim 1, further comprising:
reading a plurality of metadata and the input data from the storage units by a plurality of control units.

4. The data comparison method as described in claim 3, further comprising:
sending the candidate matching input data from the control units to the IMS units for group testing, and sending the first mismatching input data to the host for alignment processing.

5. The data comparison method as described in claim 4, further comprising:
sending a plurality of group test results from the IMS units to a group test decoder to obtain a group test decoding result, wherein the group test decoding result is used to identify or indicate the second mismatching input data; and
returning the group test decoding result from the group test decoder to the control units and sending the first mismatching input data, the matching result, and the second mismatching input data from the control units to the host.

6. The data comparison method as described in claim 1, wherein the pre-seeding operation comprises:
performing a first computation on the input data to obtain a first binary vector of the input data;
performing a second computation on the reference data to obtain a second binary vector of the reference data;
determining the input data as the candidate matching input data in response to the first binary vector being equal to the second binary vector; and
determining the input data as the first mismatching input data in response to the first binary vector being not equal to the second binary vector.

7. The data comparison method as described in claim 6, wherein:
the first and second computations include a hash function and a modulus function.

8. An In-Memory Search (IMS) device, comprising:
a plurality of IMS memory blocks for storing multiple reference data;
an accumulator coupled to the IMS memory blocks;
a selection bit vector generation unit, used to generate a selection bit vector, where the selection bit vector is used to select a plurality of target IMS memory blocks from the IMS memory blocks, and the target IMS memory blocks compare the reference data with a plurality of input data to generate a plurality of IMS comparison results, the accumulator accumulating the IMS comparison results from the target IMS memory blocks; and
a checking unit used to compare the selection bit vector with the IMS comparison results to generate a comparison result, the comparison result used to identify a mismatching input data from the input data, wherein the mismatching input data does not match the reference data.

9. The IMS device as described in claim 8, further comprising:
a test matrix unit used to set a test matrix, wherein the selection bit vector generation unit generates the selection bit vector based on the test matrix.

10. The IMS device as described in claim 8, wherein:
a plurality of bits of the selection bit vector are used as a string selection line input signals to control whether the IMS memory blocks are selected as the target IMS memory blocks.

11. The IMS device as described in claim 8, further comprising:
an adder;
a buffer, coupled to the adder;
a multiplexer, coupled to the buffer; and
a first-in-first-out (FIFO) buffer, coupled to the multiplexer,
wherein:
at each cycle, the adder adds an accumulated reference value to an accumulated value of the buffer;
the multiplexer selects a bit from the accumulated value of the buffer according to a row identifier to output to the FIFO buffer; and
the FIFO buffer stores the bit output by the multiplexer to form the selection bit vector.

12. A memory controller comprising:
a control unit coupled to and controlling a plurality of storage units and a plurality of IMS (in-memory search) units;
a pre-seeding filter coupled to the control unit; and
a group test decoder coupled to the IMS units,
wherein
the pre-seeding filter performs a pre-seeding operation on a plurality of input data stored in the storage units to pre-screen a plurality of candidate matching input data and a plurality of first mismatching input data;
the IMS units perform a group test on the candidate matching input data to compare the candidate matching input data with a plurality of reference data stored in the plurality of IMS units to generate a matching result, thereby distinguishing a plurality of matching input data and a second mismatching input data from the candidate matching input data, wherein the matching result indicates information about the matching input data which matches the reference data, while the second mismatching input data does not match the reference data; and
the IMS units send a plurality of group test results to the group test decoder to generate a group test decoding result which is used to distinguish or indicate the second mismatching input data.

13. The memory controller according to claim 12, wherein
the candidate matching input data matches the plurality of reference data, and the first mismatching input data does not match the reference data;
the first mismatching input data is sent to the host for alignment processing;
the matching result is sent to the host for location query; and
the second mismatching input data is sent to the host for alignment processing.

14. The memory controller as described in claim 12, wherein
the control unit reads a plurality of metadata and the input data from the storage units.

15. The memory controller as described in claim 14, wherein
the control unit sends the candidate matching input data to the IMS units for group testing.

16. The memory controller as described in claim 15, wherein the pre-seeding filter is configured for:
performing a first computation on the input data to obtain a first binary vector of the input data;
performing a second computation on the reference data to obtain a second binary vector of the reference data;
determining the input data as the candidate matching input data in response to the first binary vector being equal to the second binary vector; and
determining the input data as the first mismatching input data in response to the first binary vector being not equal to the second binary vector.

17. The memory controller as described in claim 16, wherein:
the first and second computations include a hash function and a modulus function.
